(19) United States
(12) Patent Application Publication
(10) Pub. No.: US 2021/0153537 A1
(43) Pub. Date: May 27, 2021

(54) COMPOUND BEVERAGE CONTAINING CORN PEPTIDES AND PUERARIA ROOT EXTRACT AND PREPARATION METHOD THEREOF

(71) Applicant: Tianjin University of Science & Technology, Tianjin (CN)

(72) Inventors: Wenzhao LI, Tianjin (CN); Miaomiao TIAN, Tianjin (CN); Jialin TANG, Tianjin (CN)

(21) Appl. No.: 16/951,073

(22) Filed: Nov. 18, 2020

(30) Foreign Application Priority Data
Nov. 21, 2019 (CN) 201911151896.2

(51) Int. Cl. A23L 33/18; A23L 2/60; A23L 2/68; A23L 2/02; A23L 33/105; A23L 29/30; A23L 29/262; A23L 5/00; A23L 2/46

(52) U.S. Cl. CPC A23L 33/18; A23L 2/60; A23L 2/68; A23L 2/02; A23V 2002/00; A23L 29/35; A23L 29/262; A23L 5/55; A23L 2/46; A23L 33/105

(57) ABSTRACT

The disclosure relates to a compound beverage containing corn peptides and Pueraria root extract which can alleviate hangover with high contents of nutrients and desired palatability and stability. The compound beverage includes components in parts by weight as follows: 0.35-0.75 parts of corn peptides, 0.1-0.5 parts of Pueraria root extract, 6-10 parts of sweetener, 0.2-1.0 parts of β-cyclodextrin, 0.1-0.3 parts of sour agent, 0.1-0.5 parts of fruit juice concentrate, 0.05-0.13 parts of stabilizer, and treated water as balance. The compound beverage containing corn peptides of the disclosure uses corn peptides as a main component. The corn peptides have high nutrition value and can supplement a variety of amino acids necessary for the human body. At the same time, Pueraria root extract is added which can lower blood pressure, dilate coronary arteries and regulate alcohol metabolism.

### TECHNICAL FIELD

The disclosure belongs to the field of research and development of food and drink, and in particular relates to a compound beverage containing corn peptides and Pueraria root extract and a preparation method thereof.

### BACKGROUND

In recent years, due to gradually accelerating pace of people's life and increasing life pressure, there are more alcohol consumers in China. Alcoholism and alcohol intoxication have become a social problem in China. A large number of studies have shown that, alcohol drinking in a small amount or a moderate amount can invigorate blood circulation, but excessive alcohol drinking can cause toxic damage to human liver, nervous system, and reproductive system. Moreover, alcohol drinking is harmful to human body and is also a threat to safe driving. Therefore, research and development of beverages for facilitating sobering up has profound significance. Such beverages can alleviate discomfort of alcohol drinkers and reduce traffic accidents to ensure safety.

Corn peptides are small polypeptides obtained by directed enzyme digestion of proteins extracted from corn and specific small peptide separation technology. They are rich in nutrients which includes various amino acids (such as glutamic acid, proline, leucine and alanine) necessary for the human body, providing amino acids and peptidergic nutrients. Moreover, as corn peptides can inhibit angiotensin converting enzyme, they have many functions, such as lowering blood pressure, facilitating sobering up (capable of inhibiting alcohol intoxication), anti-fatigue, protecting liver, and improving immunity. They are easily absorbed by the body, completely soluble in water in a wide range of pH values without turbidity and precipitation, stable to heat, unchanged in composition without loss of function, safe, reliable, non-toxic and having no side effects. They are among the most ideal raw materials for developing a modern natural functional beverage.

Pueraria root extract contains active ingredients such as puerarin, daidzein, Pueraria saponins, puerarol and mannitol, which can regulate vasodilation and vasocontraction, facilitate sobering up and protect the liver. Puerarin is a unique active ingredient in Pueraria lobata (Willd.) Ohwi var. lobata and Pueraria lobata (Willd.) Ohwi var. thomsoni (Benth.) Vaniot der Maesen. It has many biological activities such as lowering blood pressure, blood sugar and blood lipids, dilating coronary arteries, regulating alcohol metabolism, improving microcirculation, and protecting against oxidation.

Through searching, the following patent publication documents are found related to the present application:

1. A patent document entitled “Beverage containing corn peptides and processing method thereof” (CN1650731A) discloses a beverage containing corn peptides and a processing method thereof. A method includes the following steps: (1) pulverizing corn gluten meal and distributing in an aqueous solution; (2) adding an enzyme for enzymatic hydrolysis; (3) adding an organic acid for acidification, mixing in a determined ratio and conventional processing to obtain the beverage containing corn peptides. The patent document uses corn peptides as raw materials, selects appropriate enzymes for hydrolysis, and determines appropriate conditions for the enzymatic hydrolysis, so that degree of hydrolysis (DH) reaches 33% and yield of acid-soluble peptide (YASP) reaches 88%; content of polypeptide in hydrolysate reaches 200 mg/gpr, and polypeptide molecular weight is mainly distributed in a range of 1,000-2,000 Dal. A product of the patent document is stable and has a taste suitable for the public. The sensory, physical, chemical and hygienic parameters of the beverage meet the standards in Q/HRT03-2004, and a peptide content reaches 1.0 g/L.

2. A patent document entitled “Beverage containing corn peptides and fermented carrot juice and preparation method thereof” (CN105851756A) discloses a formula of the beverage containing corn peptides based on mass fraction, including carrot juice fermented by probiotics, corn protein and peptide powder, betaine, sweetener, stabilizer and water as balance. A method is implemented by fully dissolving the carrot juice fermented by probiotics, the corn protein and peptide powder, the betaine, the sweetener, the stabilizer and the water as balance, mixing, stirring uniformly, homogenizing, pasteurizing and aseptically filling to obtain the beverage containing corn peptides and fermented carrot juice. A raw stock of the carrot juice fermented by probiotics, rich in fruit and vegetable nutrients and probiotic metabolites, is combined with the corn peptides to obtain a beverage. This can cover a bitter taste of the corn peptides and increase contents of nutrients, forming a beverage containing corn peptides with a carrot fermented flavor, a bright color and a popular taste.

3. A patent document entitled “Method for preparing a beverage containing ingredients of Pueraria root and beverage containing ingredients of Pueraria root” (CN110353139A) relates to the field of healthcare beverages, in particular to a method for preparing a beverage containing ingredients of Pueraria root and a beverage containing ingredients of Pueraria root. The method for preparing a beverage containing ingredients of Pueraria root includes the following steps: (1) adding Rhizopus oryzae powders to cooked Pueraria roots, mashing at 25-30° C. (2) adding hot water to mashed Pueraria roots, heating to 80-100° C. and holding for 30-60 min to obtain a Pueraria root material; (3) subjecting the Pueraria root material to lactic acid bacteria fermentation, yeast fermentation and Acetobacter aceti fermentation in sequence to obtain a final acidity of the Pueraria root material ≥15 g/L, and ending the fermentation; (4) taking a supernatant for formulation, filtering and sterilizing to obtain the beverage containing ingredients of Pueraria root. The method provided by the patent document enhances the extraction of puerarin and flavonoids, and improves nutritional value of the beverage containing ingredients of Pueraria root. At the same time, flavor substances produced by different strains can completely transform innate odor of the Pueraria root and produce a pleasant smell, which improves commodity value of the product.

By comparison, the first patent publication document includes a main formula of corn peptides, white sugar, and other auxiliary materials. The formula of this patent application contains no flavors, which preserves an original flavor of the corn peptides to the greatest extent but has poor taste due to obvious bitterness of the corn peptides. The second patent publication document includes a main formula of corn protein and peptide powder, carrot juice fermented by probiotics, betaine, sweetener, and stabilizer. The formula of the document contains a stabilizer and a fermented carrot juice to bring certain flavor to the beverage containing corn peptides, cover the innate bitter taste of the corn peptides, and increase number of nutrients of the beverage containing corn peptides. A beverage containing corn peptides with a carrot fermentation flavor, a bright color and a popular taste is formed. But the corn peptides do not have a full play in nutritional functions such as supplementing the human body with amino acids and facilitating sobering up. The third patent publication document discloses preparation of the beverage containing ingredients of Pueraria root, including cooking, mashing, and fermenting with different microorganisms to enhance contents of puerarin and flavonoids in the beverage. However, no extraction and purification is carried out to obtain an extract from the Pueraria root. Therefore, comparisons show that, the patent application of the disclosure is essentially different from the above patent publication documents.

### SUMMARY

The disclosure aims to expand applications of corn peptides and use Pueraria root extract and corn peptide powder as main raw materials to develop a compound beverage with a function of facilitating sobering up, a high content of nutrients, desired palatability and stability. The disclosure has important practical value and economic value. Through further development and utilization of the corn peptides, corn processing companies can have greatly improved economic benefits. Addition of the Pueraria root extract can also open up a new way for development of compound beverages.

The disclosure adopts the following technical solutions to solve technical problems:

A compound beverage containing corn peptides and Pueraria root extract, including components in parts by weight as follows:

| | | |
|---|---|---|
| corn peptide powder | 0.35-0.75 | parts |
| Pueraria root extract | 0.1-0.5 | parts |
| sweetener | 6-10 | parts |
| β-cyclodextrin | 0.2-1.0 | parts |
| sour agent | 0.1-0.3 | parts |
| fruit juice concentrate | 0.1-0.5 | parts |
| stabilizer | 0.05-0.13 | parts |

| | |
|---|---|
| treated water | as balance. |

Moreover, the sweetener is a first grade pure white sugar, honey or the like.

Moreover, the β-cyclodextrin is a food grade i-cyclodextrin.

Moreover, the sour agent is a food grade citric acid or malic acid.

Moreover, the stabilizer is a food grade carboxymethyl cellulose (CMC).

A method for preparing a compound beverage containing corn peptides and Pueraria root extract, including the following steps:

step (1): mixing weighed corn oligopeptide, Pueraria root extract, white sugar and other solid materials uniformly;

step (2): dissolving: adding water to mixed solid materials, and stirring continuously to achieve complete dissolution to obtain a transparent solution;

step (3): formulating: adding citric acid, strawberry juice concentrate, honey and the like, stirring continuously to achieve dissolution, and sealing;

step (4): sterilizing: normal pressure sterilizing with hot water at 100° C. as medium for 3-12 min;

step (5): filling: filling and sealing heat treated materials which are still hot, and allowing to stand still to cool to room temperature;

step (6): examining color, aroma and taste of a compound beverage containing corn peptides, where it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

The disclosure has the following advantages and beneficial effects:

1. The compound beverage containing corn peptides of the disclosure uses corn peptides as a main component. The corn peptides are small polypeptides obtained by directed enzyme digestion of proteins extracted from corn and specific small peptide separation technology. They are rich in nutrients which can provide consumers with a variety of amino acids, facilitate sobering up and anti-fatigue, and protect the liver. They are among the most ideal raw materials for developing a modern natural functional beverage, and also improve comprehensive utilization of corn.

2. The compound beverage containing corn peptides of the disclosure includes Pueraria root extract as an auxiliary material. The Pueraria root extract contains many active ingredients such as puerarin, daidzein, Pueraria saponins, puerarol and mannitol, which can regulate vasodilation and vasocontraction, lower blood pressure and blood lipids, prevent from aging, eliminate and discharge toxins, alleviate hangover and protect the liver. Thus, functions of the Pueraria root can be fully used to increase market utilization thereof.

3. The compound beverage containing corn peptides of the disclosure can effectively improve utilization of corn to avoid resource waste. Moreover, the compound beverage containing corn peptides maintains original nutrients to the maximum extent during a production process. Compared with similar products on the market, this product has advantages such as high nutritional value, hangover alleviation and liver protection. The disclosure provides a new product for facilitating sobering up on the market which has a low cost and is convenient to drink and carry.

### DETAILED DESCRIPTION

The disclosure is further illustrated with reference to the following examples which are illustrative and not restrictive. The scope of protection of the disclosure is not limited by the following examples.

Raw materials used in the disclosure, unless otherwise specified, are all conventional commercially available products, and methods used in the disclosure, unless otherwise specified, are all conventional methods in the field.

A method for preparing a compound beverage containing corn peptides and Pueraria root extract provided by the disclosure is roughly described as follows:

### Example 1

A beverage containing corn peptides and Pueraria root extract included components in parts by weight as follows:

| | | |
|---|---|---|
| corn peptides | 0.55 | parts |
| Pueraria root extract | 0.3 | parts |
| β-cyclodextrin | 0.4 | parts |
| white sugar | 8 | parts |
| honey | 5 | parts |
| strawberry juice concentrate | 0.3 | parts |
| citric acid | 0.2 | parts |
| CMC | 0.07 | parts. |

A method for preparing the above beverage containing corn peptides and Pueraria root extract included the following steps:

Step (1): weighed corn oligopeptide, the Pueraria root extract, the white sugar and other solid materials were mixed uniformly.

Step (2): dissolving: water was added to mixed solid materials, and stirred continuously to achieve complete dissolution to obtain a transparent solution.

Step (3): formulating: the citric acid, the strawberry juice concentrate, the honey and the like were added, stirred continuously to achieve dissolution, and sealed.

Step (4): sterilizing: normal pressure sterilizing was carried out with hot water at 100° C. as medium for 3-12 min.

Step (5): filling: heat treated materials which were still hot were filled, sealed, and allowed to stand still to cool to room temperature.

Step (6): color, aroma and taste of a compound beverage containing corn peptides were examined, where it was required that the compound beverage was sweet and sour, palatable, soft and delicate, with a desired taste; the color was uniform and shiny; there was a sweet smell and no bad odor; the beverage was delicate, uniformly turbid without layering, precipitation, bubbles and impurities. A stable product which was not spoiled was ensured to obtain the compound beverage containing corn peptides.

Test results of main quality indicators of the above compound beverage containing corn peptides were as follows:

(1) Color: the compound beverage containing corn peptides prepared according to the above technical solution had a uniform and shiny color.

(2) Flavor: the compound beverage containing corn peptides prepared according to the above technical solution had no bad odor, a smell not so harmony, and a strong aftertaste.

(3) Taste: the compound beverage containing corn peptides prepared according to the above technical solution was sweet and sour, and not peculiar, giving a relatively desired taste.

(4) Organizational state: the compound beverage containing corn peptides prepared according to the above technical solution was delicate and uniformly turbid, without layering, precipitation, bubbles and impurities.

### Example 2

A compound beverage containing corn peptides and Pueraria root extract included components in parts by weight as follows:

| | | |
|---|---|---|
| corn peptides | 0.55 | parts |
| Pueraria root extract | 0.3 | parts |
| β-cyclodextrin | 0.4 | parts |
| white sugar | 8 | parts |
| honey | 5 | parts |
| cranberry juice concentrate | 0.5 | parts |
| citric acid | 0.2 | parts |
| CMC | 0.07 | parts. |

A method for preparing the above beverage containing corn peptides and Pueraria root extract included the following steps:

Step (1): weighed corn oligopeptide, the Pueraria root extract, the white sugar and other solid materials were mixed uniformly.

Step (2): dissolving: water was added to mixed solid materials, and stirred continuously to achieve complete dissolution to obtain a transparent solution.

Step (3): formulating: the citric acid, the cranberry juice concentrate, the honey and the like were added, stirred continuously to achieve dissolution, and sealed.

Step (4): sterilizing: normal pressure sterilizing was carried out with hot water at 100° C. as medium for 3-12 min.

Step (5): filling: heat treated materials which were still hot were filled, sealed, and allowed to stand still to cool to room temperature.

Step (6): color, aroma and taste of a compound beverage containing corn peptides were examined, where it was required that the compound beverage was sweet and sour, palatable, soft and delicate, with a desired taste; the color was uniform and shiny; there was a sweet smell and no bad odor; the beverage was delicate, uniformly turbid without layering, precipitation, bubbles and impurities. A stable product which was not spoiled was ensured to obtain the compound beverage containing corn peptides.

Test results of main quality indicators of the above compound beverage containing corn peptides were as follows:

(1) Color: the compound beverage containing corn peptides prepared according to the above technical solution had a uniform and shiny color.

(2) Flavor: the compound beverage containing corn peptides prepared according to the above technical solution had a sweet smell and a strong aftertaste.

(3) Taste: the compound beverage containing corn peptides prepared according to the above technical solution was sweet and sour, and not peculiar, giving a relatively desired taste.

(4) Organizational state: the compound beverage containing corn peptides prepared according to the above technical solution was delicate and uniformly turbid, without layering, precipitation, bubbles and impurities.

Example 3 A beverage containing corn peptides and Pueraria root extract included components in parts by weight as follows:

| | | |
|---|---|---|
| corn peptide | 0.55 | parts |
| Pueraria root extract | 0.3 | parts |
| β-cyclodextrin | 0.4 | parts |
| white sugar | 8 | parts |
| honey | 5 | parts |
| strawberry juice concentrate | 0.3 | parts |
| malic acid | 0.2 | parts |
| CMC | 0.11 | parts. |

A method for preparing the above beverage containing corn peptides and Pueraria root extract included the following steps:

Step (1): weighed corn oligopeptide, the Pueraria root extract, the white sugar and other solid materials were mixed uniformly.

Step (2): dissolving: water was added to mixed solid materials, and stirred continuously to achieve complete dissolution to obtain a transparent solution.

Step (3): formulating: the malic acid, the strawberry juice concentrate, the honey and the like were added, stirred continuously to achieve dissolution, and sealed.

Step (4): sterilizing: normal pressure sterilizing was carried out with hot water at 100° C. as medium for 3-12 min.

Step (5): filling: heat treated materials which were still hot were filled, sealed, and allowed to stand still to cool to room temperature.

Step (6): color, aroma and taste of a compound beverage containing corn peptides were examined, where it was required that the compound beverage was sweet and sour, palatable, soft and delicate, with a desired taste; the color was uniform and shiny; there was a sweet smell and no bad odor; the beverage was delicate, uniformly turbid without layering, precipitation, bubbles and impurities. A stable product which was not spoiled was ensured to obtain the compound beverage containing corn peptides.

Test results of main quality indicators of the above compound beverage containing corn peptides were as follows:

(1) Color: the compound beverage containing corn peptides prepared according to the above technical solution had a uniform and shiny color.

(2) Flavor: the compound beverage containing corn peptides prepared according to the above technical solution had no bad odor, a smell not so harmony, and a strong aftertaste.

(3) Taste: the compound beverage containing corn peptides prepared according to the above technical solution was sweet and sour, but slightly peculiar, giving a relatively poor taste.

(4) Organizational state: the compound beverage containing corn peptides prepared according to the above technical solution was delicate and uniformly turbid, without layering, precipitation, bubbles and impurities.

1. A compound beverage containing corn peptides and Pueraria root extract, comprising components in parts by weight, based on a total of 100 parts, as follows:

| | | |
|---|---|---|
| corn peptide powder | 0.35-0.75 | parts |
| Pueraria root extract | 0.1-0.5 | parts |
| sweetener | 6-10 | parts |
| β-cyclodextrin | 0.2-1.0 | parts |
| sour agent | 0.1-0.3 | parts |
| fruit juice concentrate | 0.1-0.5 | parts |
| stabilizer | 0.05-0.13 | parts |
| | |
|---|---|
| treated water | as balance. |

2. The compound beverage containing corn peptides and Pueraria root extract according to claim 1, wherein the sweetener is a food grade white sugar, honey or the like.

3. The compound beverage containing corn peptides and Pueraria root extract according to claim 1, wherein the β-cyclodextrin is a food grade β-cyclodextrin powder.

4. The compound beverage containing corn peptides and Pueraria root extract according to claim 1, wherein the stabilizer is a food grade carboxymethyl cellulose (CMC) or the like.

5. The compound beverage containing corn peptides and Pueraria root extract according to claim 1, wherein the sour agent is a food grade citric acid or malic acid or the like.

6. The compound beverage containing corn peptides and Pueraria root extract according to claim 1, wherein the fruit juice concentrate is a fruit juice concentrate of strawberry or cranberry or the like.

7. The compound beverage containing corn peptides and Pueraria root extract according to claim 6, wherein the Pueraria root extract is a food grade Pueraria root aqueous extract.

8. The compound beverage containing corn peptides and Pueraria root extract according to claim 1, wherein the treated water meets requirements on water for beverage.

9. A method for preparing the compound beverage containing corn peptides and Pueraria root extract according to claim 1, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

10. A method for preparing the compound beverage containing corn peptides and Pueraria root extract according to claim 2, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

11. A method for preparing the compound beverage containing corn peptides and Pueraria root extract according to claim 3, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

12. A method for preparing the compound beverage containing corn peptides and Pueraria root extract according to claim 4, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

13. A method for preparing the compound beverage containing corn peptides and Pueraria root extract according to claim 5, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

14. A method for preparing the compound beverage containing corn peptides and Pueraria root extract according to claim 6, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

15. A method for preparing the compound beverage containing corn peptides and Pueraria root extract according to claim 7, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.

16. A method for preparing the compound beverage containing corn peptides and Pueraria root extract according to claim 8, comprising the following steps:
step (1): mixing weighed corn oligopeptide, the Pueraria root extract, white sugar and other solid materials uniformly;
step (2): dissolving: adding water to mixed solid materials, and stirring continuously to achieve complete dissolution to obtain a transparent solution;
step (3): formulating: adding citric acid, strawberry juice concentrate, honey and the like, stirring continuously to achieve dissolution, and sealing;
step (4): sterilizing: normal pressure sterilizing with hot water at 100° C. as medium for 3-12 min;
step (5): filling: filling and sealing heat treated materials which are still hot, and allowing to stand still to cool to room temperature;
step (6): examining color, aroma and taste of a compound beverage containing corn peptides, wherein it is required that the compound beverage is sweet and sour, palatable, soft and delicate, with a desired taste; the color is uniform and shiny; there is a sweet smell and no bad odor; the beverage is delicate, uniformly turbid without layering, precipitation, bubbles and impurities; and ensuring a stable product not spoiled to obtain the compound beverage containing corn peptides.
